(19) United States
(12) Patent Application Publication
(10) Pub. No.: US 2019/0294208 A1
(43) Pub. Date: Sep. 26, 2019

(54) Da'cor Headdress with Display Unit

(71) Applicant: Tremaine Jackson, West Covina, CA (US)

(72) Inventor: Tremaine Jackson, West Covina, CA (US)

(21) Appl. No.: 15/928,279

(22) Filed: Mar. 22, 2018

(51) Int. Cl. G06F 1/16; G06F 3/01

(52) U.S. Cl. CPC G06F 1/163; A63F 13/25; G06F 3/012

(57) ABSTRACT

A headdress system includes an earpiece having speakers surrounding a display unit. A user interface is operative to receive input from a user. The headdress system includes a bendable flexible head unit. A control panel is coupled to the display unit, responsive to said user input, and operative to execute audio and display images on said display unit based on said user input.

### FIELD OF THE INVENTION

The present invention relates to a head-set with a detachable, handheld ear piece, having a small monitor inside the listening unit that is surrounded by high quality small speakers placed at different vantage points. The ear-piece can thus be used for receiving audio sounds by either detaching from the headdress in ways to enable the user to view the inner monitor in the best possible manner. Moreover, the head-set is framed in a bendable headdress unit, which not only functions as the remote, but may bend to conform to one's: head, thigh, or knee for listening and viewing in a hands free mode.

### BACKGROUND OF THE INVENTION

In many circumstances, display systems are integrated into head mounted devices (HMD) such as stereoscopic headsets to enable usage in gaming, vision evaluation, psychological testing, training, and the like. However, these integrated devices are non-detachable apart from limited interactivity resulting in constraints in their freedom of operations. To enable a realistic and interactive viewing and hearing experience in its existing as well as in forms where some of the components can be isolated from the integrated device as per suitability of the user, a compact HMD is an essential pre-requisite.

The present invention is of an integrated head set with freedom of usage enhanced to a substantial level for optimum user satisfaction. The user may use the headset in a conventional manner or by removing the headset from the housing, activate the headset, and use the monitor embedded in the device in an interactive manner through the headset.

To establish the uniqueness of the present innovation, a discrete survey of similar patents revealed the following:

CA 2696925 A1 titled, “Integrated field-configurable headset and system” discusses an integrated field-configurable headset system comprising a standard media input interface, a stereoscopic image decoder for generating first and second flows of images, a digital image processor for editing images of the first image flow, a second image processor for editing images of the second image flow, display means for displaying images from the first processor, and display means for displaying images from the second processor. The system is advantageously used to display images to a left eye and a right eye of a user respectively besides altering the images digitally to take into account intrinsic limitations of the system and/or to match a user profile.

U.S. Pat. No. 9,625,721 B2 titled, “Method, digital image processor and video display system for digitally processing a video signal” talks of a headset system connectable to a video source for receiving a video signal through a wired or wireless communication link that comprises of a head mounted device, a user interface and a base station. The head mounted device displays a video image to the user via an integrated video display and also comprises an integrated data image processor and optical lenses positioned in front the video display. The data image processor effects high speed real time modification of an image frame of the video signal. The video display is in communication with the data image processor for displaying processed images from the digital image processor. The user interface allows for building a user profile and storing the user profile in the memory of the digital image processor. The base station comprises an input interface connectable to the communication link, and an output interface for forwarding the communication signal to the video display.

U.S. Pat. No. 8,655,004 B2 titled, “Sports monitoring system for headphones, earbuds and/or headsets” discusses a monitoring system that can be placed proximate to the head or ear of a user. The monitoring system can be used with headphones, earbuds or headsets. The monitoring system can, for example, be used to monitor user activity, such as during exercise or sporting activities. The positioning of the monitoring system can also facilitate sensing of other user characteristics (e.g., biometric data), such as temperature, perspiration and heart rate. The monitoring system can also be used to control an electronic device. In one embodiment, the monitoring system facilitates user control of the electronic device using head gestures.

### SUMMARY OF INVENTION

An object of the present invention is to provide a detachable and handheld ear piece mountable on a specially designed headdress.

A still further object of the present invention is to provide a bendable headdress unit which performs the functions of headset for attaching the ear piece on any of the two sides of the headdress.

Another object of the present invention is to transform the headphones at the discretion of the user, into a sophisticated interactive display platform, in addition to reproducing music and sound.

A still further object of the present invention is to provide a portable and interchangeable display platform which could be worn over the head. The contents of the display can be interactive with a separate external controlling device (e.g. Smartphone or Tablet) nearby.

Another object of the present invention is to provide a headdress which optionally functions as a remote for interactively displaying and controlling the audio and content on the display platform defined by a user.

A further object of the present invention is to provide a headdress unit which functions as a support to the display unit when worn on the thigh, knee and or hand for viewing as well as listening to the content hands free.

### BRIEF DESCRIPTION OF THE DRAWINGS

The present invention is described with reference to the following drawings, wherein like reference numbers denote substantially similar elements:

FIG. 1 illustrates an embodiment of the present invention, wherein the headdress unit and the earpiece are attached.

FIG. 2 is an illustration of the backside of the hand held earpiece (1), depicting the heat vents of the speaker.

FIG. 3 illustrates the perspective back view of the headdress of the present invention depicting the monitor embedded inside the handheld ear piece.

FIG. 4A illustrates the handheld ear piece with the embedded monitor of the present invention, where the headdress unit is detached from the handheld ear piece. Included near the innermost bottom of unit is a USB/or HDMI port (8) that supports data transfer at the rate of 12 Mbps which allows for data recognition and or transfer when inserted into the corresponding connection port (9) of the detached headdress unit.

FIG. 4B illustrates the detached headdress unit having raised buttons/sliders or sensors as well as connection port (9) which acts as the fixation/charging point of the USB/insert (8) as described in FIG. 4A. The detached headdress unit allows the ribs to bend over knee or thigh while having the earpiece monitor affixed at the top of said headdress for viewing.

FIG. 5 is a back perspective view, illustrating the assembled embodiment of the headdress unit and the ear piece.

FIG. 6 is a side perspective view, illustrating the assembled embodiment of the headdress unit and the ear piece.

FIG. 7 is a front perspective view, illustrating the assembled embodiment of the headdress unit and the ear piece.

FIG. 8 is a back view of earpiece detached from the headdress unit.

FIG. 9 is a back perspective view of earpiece detached from the headdress unit.

FIG. 10 is a side view of the detached hand held ear piece unit.

FIG. 11 is a front view of the detached hand held ear piece unit with the monitor/display unit embedded within.

FIG. 12 is front perspective view of the detached headdress unit.

FIG. 13 is side perspective view of the detached headdress unit.

FIG. 14 is back perspective view of the detached headdress unit.

FIG. 15 is a schematic location of the monitor main components.

### DETAILED DESCRIPTION OF THE PREFERRED EMBODIMENT

The Da'cor Headdress of the present invention is a one eared head-set and viewing device in a two piece unit comprising a top part which is the bendable headdress unit and a front part that includes a handheld ear piece, having high quality speakers, and surrounding the monitor which is detachable.

In an embodiment of the present invention, the top part of the device which is the bendable headdress unit functions as a remote, wherein, the headdress unit is designed, having raised buttons/sliders or sensors, which allow the user to control the device. The raised surfaces allow the user to find buttons without visually looking at them. The said top part of the headdress unit comprises of speakers, microphone, volume control panel (Volume +/−) and small rechargeable battery as is depicted in figure.

The front part comprises of the display unit, foldable lenses, hardware circuit, rechargeable battery, control panel with buttons (for example: up, down, left, right, set).

In another embodiment, the detachable bendable headdress unit functions as a support to the display unit when worn on the thigh, knee or hand for viewing as well as listening to the content hands free. In this embodiment the earpiece with the monitor can be detached from the headdress unit and the earpiece can be affixed to the back arch of the bent unit for viewing and controlling the device hands free. Moreover, the headdress unit can be bent to conform to the users head, thigh or knee, for listening and viewing proposes, hands free, due to its flexible material.

In another embodiment of the present invention the portable and/or interchangeable earpiece with the display unit is affixed on either the right or left side of the headdress unit that holds the headset with the display unit. The display unit along with the bendable headdress unit forms an integrated interactive display platform.

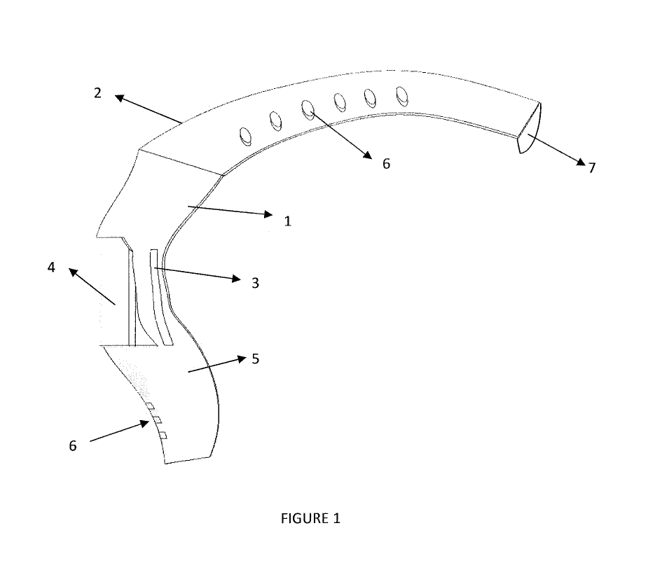

The above embodiment is illustrated in FIG. 1, which is shown, depicting the headdress wherein the said bendable headdress (2) having flexible ribs, allows the said headdress (2) flexibility in bending, which is attached to the hand held ear piece (1). The said handheld earpiece (1) is shown to comprise of an embedded monitor (3) enclosed by the speaker (5), the speaker having heat vents or holes (6). A fastener (7) is provided with the headdress to secure the said headdress in place.

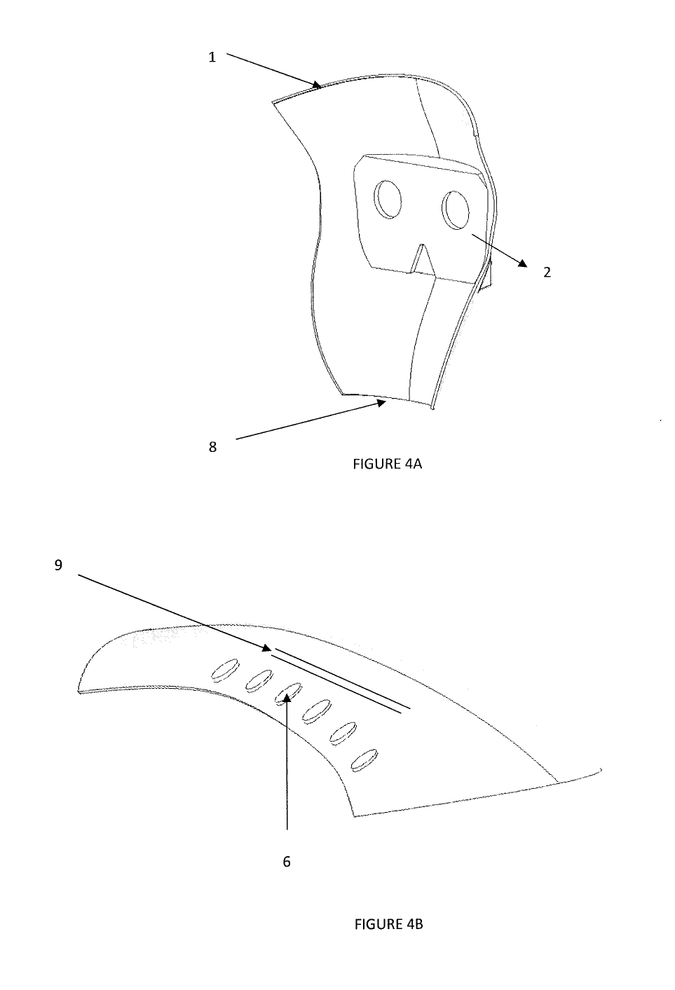

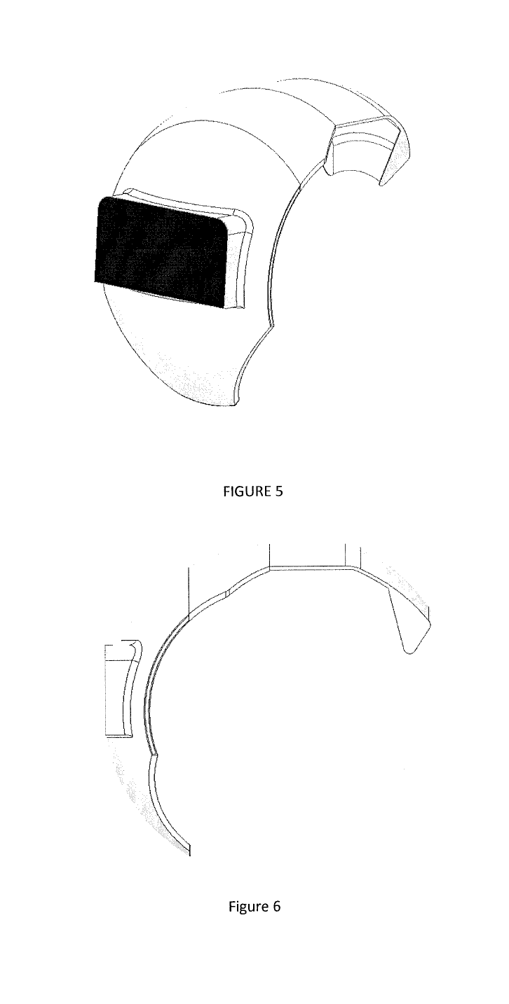

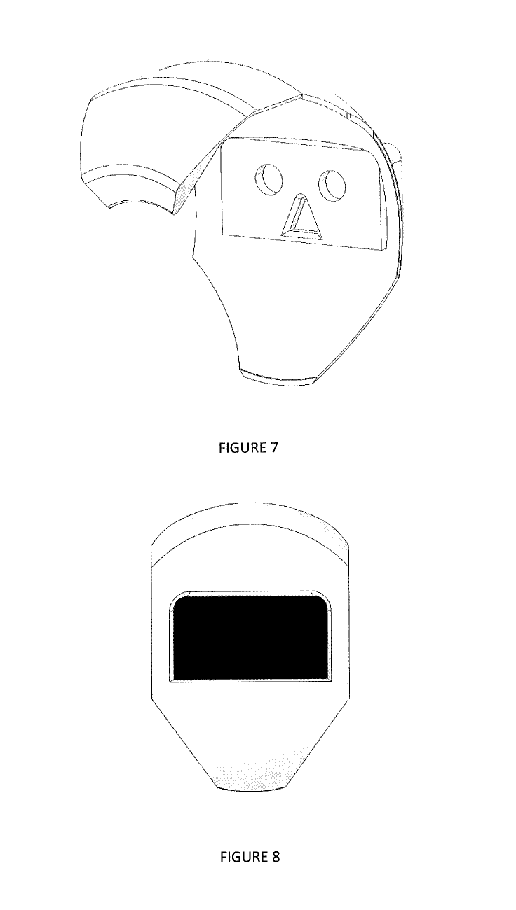

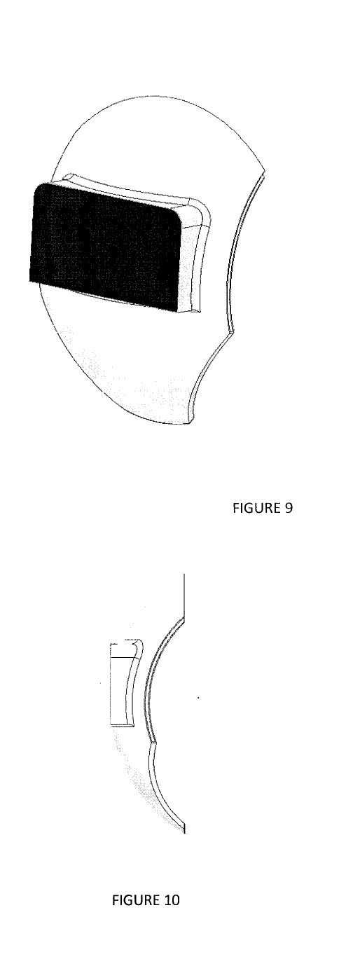

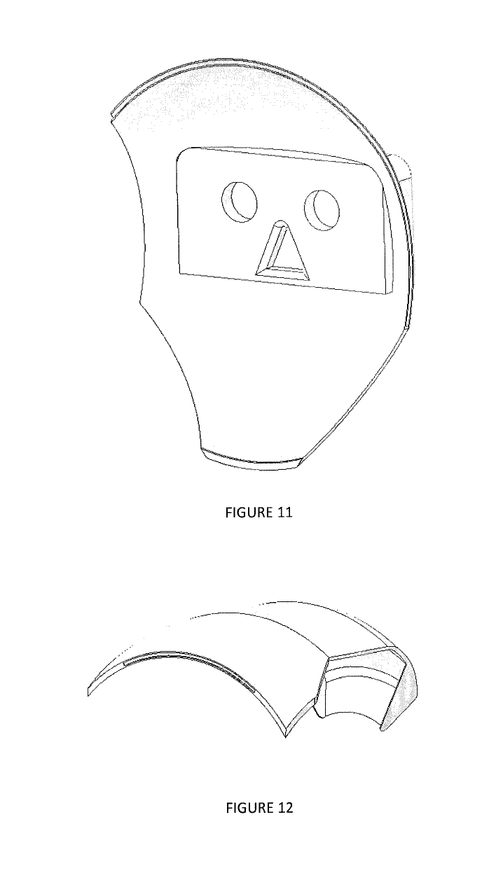

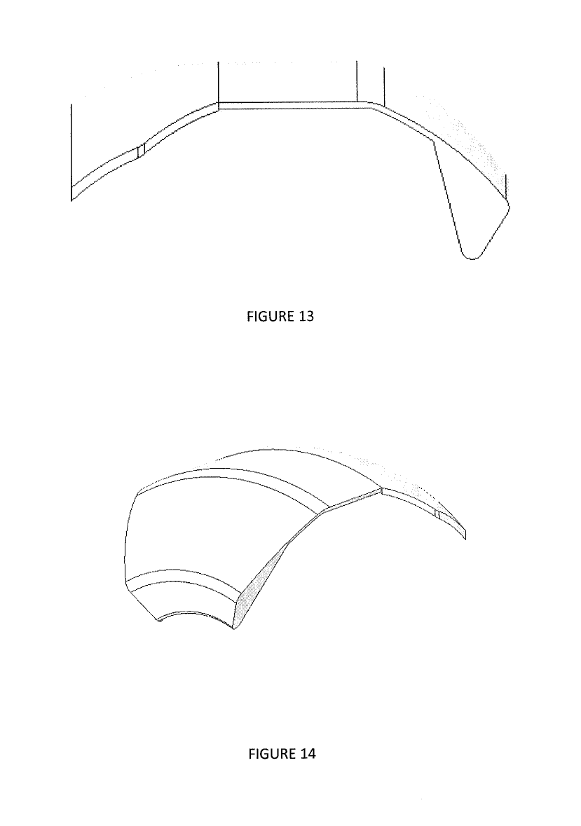

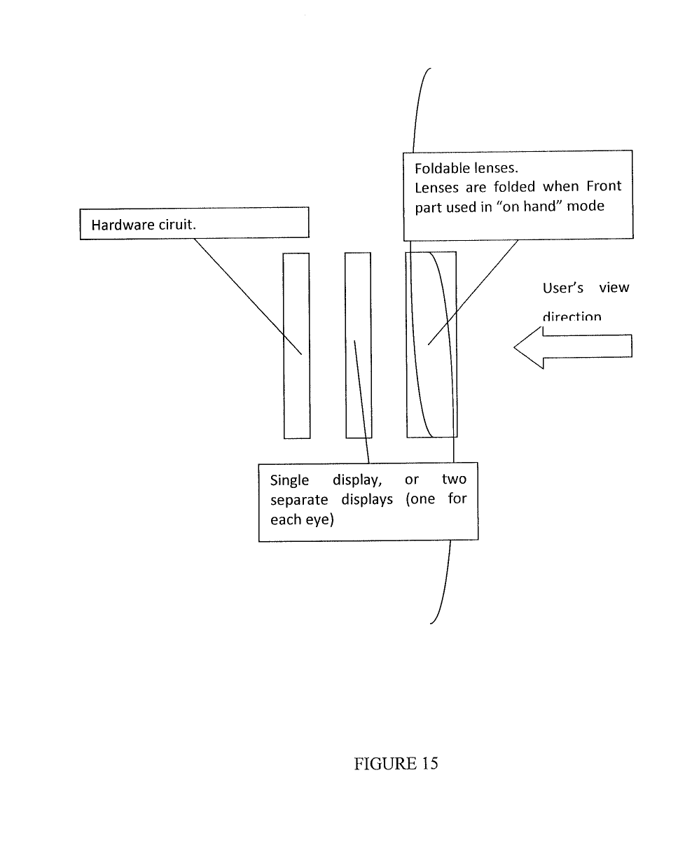

Another embodiment is illustrated in FIG. 4, wherein the headdress unit (2) is detached from the handheld ear piece (1). The headdress unit shows raised buttons/sliders or sensors (6), which allows the user to control the hand held ear piece (1) when detached or the headdress device as a whole when both the headdress unit (2) and the ear piece (1) are attached.

In FIG. 4A, the headdress unit is detached from the handheld ear piece. Included near the innermost bottom of unit is a USB/or HDMI port (8) that supports data transfer at the rate of 12 Mbps which allows for data recognition and or transfer when inserted into the corresponding connection port (9) of the detached headdress unit.

FIG. 4B illustrates the said detached headdress unit having raised buttons/sliders or sensors (6) and connection port (9) which acts as the fixation point of the said USB/insert (8) as described in FIG. 4A. The said detached headdress unit allows the ribs to bend over knee or thigh while having the earpiece monitor affixed at the top of said headdress for viewing.

The top part of the headdress unit can supply or control the necessary audio signal for the headphones to play and to deliver a proper video or static/animated image signal for the display platform to display via sensors or with wireless devices such as Bluetooth. The top part of the headdress unit can also be used for turning on/off and/or to configure various functions such as volume control, spectrum equalizer or other signal processing functions that the display unit may have.

The display platform is similar to a microcomputer, having its own central processing unit (CPU), memory, storage and necessary interfaces to perform the display functions based on the information and instructions sent by the top part of the bendable headdress unit via the link, connecting the top part of the headdress unit and the headphone/display platform. The contents sent over the link may be stored in the internal storage first and then displayed in a way determined by the instructions sent.

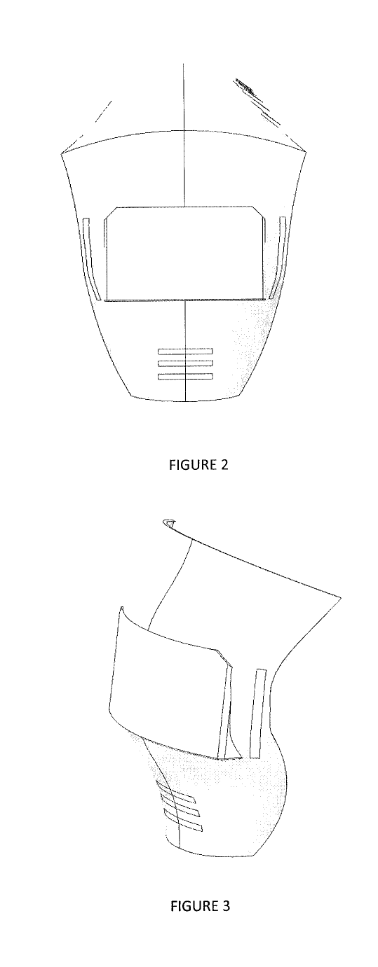

In an embodiment of the present invention, and referring to FIGS. 1 through 3 and 5, the one eared device includes an earphone integrated with a display unit and a bendable head unit. The bendable headdress unit is further accompanied by fasteners (7) for securing the device. The system includes a pair of monitors or display units for both the eyes encased by speakers around the said display unit. The display unit is coupled with foldable lenses, hardware circuit, rechargeable battery, and control panel with buttons for operating in desired directions of top, bottom, left and right. The user interface is operative to receive input from the user and the control panel is responsive to the user input, which is via the headdress unit which functions as a remote control to the earphone and operates to execute the audio signal and display images on the display unit based on the user input.

The size of the display unit ranges between 4 inches (101.6 mm) and 6 inches (152.4 mm).

The display unit may be single or it may be double separate for both eyes.

In an embodiment of the present invention, the user interface includes a data communication interface operative to facilitate data communication between the headphone system and an external system like a smart phone, wherein the external calls can be attended and answered by the user, by temporarily interrupting the video or audio operation.

The headdress unit of the present invention is made of flexible material depending upon the purpose of the unit. For example polypropylene is used for rigid parts, neoprene for soft body-contact parts, nylon, fabric, bendable plastic for headdress unit design and rubber for headdress fixation on user's head/hand/knee.

In another embodiment of the present invention, the headdress is affixed inside specially designed helmets, for both civilian and combat use. In this embodiment, the helmet is worn with a built-in headdress and or with the ear piece attached inside the helmet, affixed to the inner helmet via a USB port. The USB port may be positioned at each earpiece of the helmet. These specially designed helmets have additional fasteners/hooks on the inside of the helmet. In addition, the helmet may include a plurality of sensors in electric communication with the earpiece.

It will be understood that the present disclosure is not limited to the embodiments disclosed herein as such embodiments may vary somewhat. It is also to be understood that the terminology employed herein is used for the purpose of describing particular embodiments only and is not intended to be limiting in scope.

I claim:

1. A headdress system comprising:
a bendable flexible head unit;
an earpiece having speakers surrounding a display unit;
a user interface operative to receive input from a user; and
a control panel coupled to the display unit, responsive to said user input, and operative to execute audio and display images on said display unit based on said user input.

2. The headdress system of claim 1, wherein said bendable flexible head unit functions as a remote for controlling audio signal for the speakers to play and to deliver a video or static/animated image signal for the display unit to display via sensors.

3. The headdress system of claim 1, wherein said bendable head unit is detachable from said ear piece which is integrated with the display unit.

4. The headdress system of claim 1 wherein, the said flexible head unit when worn on the head as a complete headdress unit is integrated with the earpiece and the display unit and wherein said head unit functions as a remote to control and configure a volume, a spectrum equalizer, and signal processing functions.

5. The headdress system of claim 3, wherein the detachable bendable head unit functions as a support to the display unit when worn on the thigh, knee, or hand for viewing as well as listening to the content hands free.

6. The headdress system of claim 3, wherein:
said handheld earpiece includes a USB port;
said detachable bendable head unit includes a connection port configured for receiving the USB port.

7. The headdress system of claim 3, wherein said earpiece is integrated with the monitor and is detached from the headdress unit and the earpiece is affixed to a back arch of the bendable head unit for viewing and controlling the device hands free.

8. The headdress system of claim 1, wherein said user interface includes a data communication interface operative to facilitate data communication between said headdress system and an external system.

9. The headdress system of claim 7, wherein the external system is a video or audio phone.

10. The headdress system of claim 7, wherein the external system is a tablet.

11. The headdress system of claim 1, wherein the said display unit is a single monitor.

12. The headdress system of claim 1, wherein the said display unit includes two monitors.

13. The headdress system of claim 1, wherein the said display unit is coupled with lenses, a hardware circuit, a rechargeable battery, and a control panel with buttons for operating in desired directions of top, bottom, left and right.

14. The headdress system of claim 12, wherein said display unit is coupled with foldable lenses when said headdress unit functions as a support to the detachable earpiece embedding the display unit.

15. The headdress system of claim 1, wherein:
said earpiece is positioned inside a helmet;
said earpiece includes a USB port;
a plurality of sensors are mounted in said helmet and electrically connected to said earpiece.
